(19) United States
(12) Patent Application Publication
(10) Pub. No.: US 2008/0203195 A1
(43) Pub. Date: Aug. 28, 2008

(54) Energy autonomous hand shower interface

(76) Inventor: Randall Paul Schmitt, Clinton Township, MI (US)

Correspondence Address: BAKER & DANIELS LLP, 300 NORTH MERIDIAN STREET, SUITE 2700, INDIANAPOLIS, IN, 46204, US

(21) Appl. No.: 11/710,142

(22) Filed: Feb. 23, 2007

(51) Int. Cl. B05B 1/14

(52) U.S. Cl. 239/548

(57) ABSTRACT

A fluid delivery apparatus including an energy harvesting device to generate energy for communicating with a fluid control device.

### BACKGROUND AND SUMMARY OF THE INVENTION

The present invention relates generally to a fluid delivery apparatus and, more particularly, to a power source for the user interface of a hand-held fluid delivery apparatus.

According to an illustrative embodiment of the present disclosure, a hand-held fluid delivery apparatus includes a housing, a sprayhead coupled to the housing, and an energy harvesting device supported by the housing.

According to a further illustrative embodiment of the present disclosure, a hand-held fluid delivery apparatus includes a housing having a fluid inlet and a fluid outlet, and a user interface coupled to the housing. The user interface includes a user input member, an energy harvesting device operably coupled to the user input member, and a transmitter electrically coupled to the energy harvesting device. The energy harvesting device is configured to convert mechanical energy from the user input member to electrical energy supplied to the transmitter.

According to a further illustrative embodiment of the present disclosure, a fluid delivery apparatus includes a fluid control device, and a user interface including an energy autonomous switch, a transmitter electrically coupled to the energy autonomous switch and configured to emit a signal to the fluid control device. The energy autonomous switch is configured to convert mechanical energy to electrical energy supplied to the transmitter.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a diagrammatic view of an illustrative embodiment fluid delivery apparatus;

FIG. 2 is a fluid delivery apparatus with the user interface illustrated schematically;

FIG. 3 is a further perspective view of the illustrative hand-held fluid delivery apparatus;

FIG. 4 is a partially exploded perspective view of the fluid delivery apparatus of FIG. 3; and

FIG. 5 is a perspective view of a further illustrative embodiment fluid delivery apparatus.

### DETAILED DESCRIPTION OF THE DRAWINGS

The embodiments of the invention described herein are not intended to be exhaustive or to limit the invention to precise forms disclosed. Rather, the embodiment selected for description have been chosen to enable one skilled in the art to practice the invention. Although the disclosure is described in connection with water, it should be understood that additional types of fluids may be used.

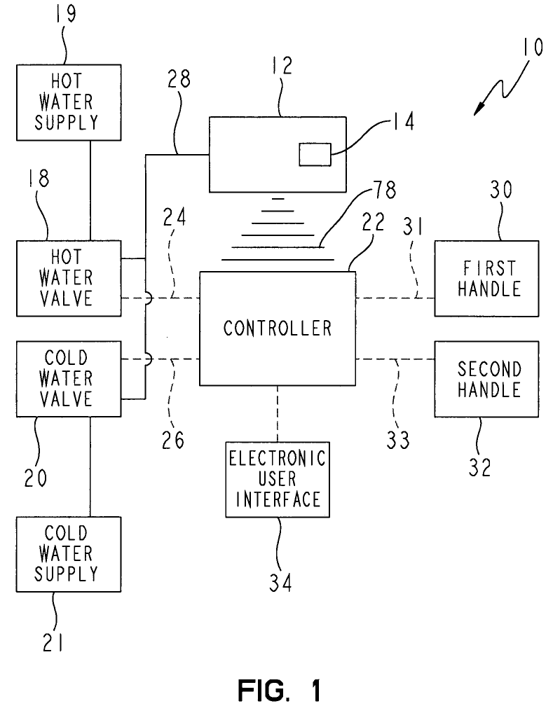

Referring to FIG. 1, an illustrative embodiment fluid delivery system 10 is described. Fluid delivery system 10 includes a hand-held fluid delivery apparatus 12, illustratively a hand shower of the type used in connection with a bathtub or shower (not shown). Illustrative bathtubs and showers for use with the hand shower 12 are detailed in International Patent Application Serial No. PCT/US2006/044023, filed Nov. 13, 2006, entitled “INTEGRATED BATHROOM ELECTRONIC SYSTEM,” which is expressly incorporated by reference herein. While a hand shower 12 is described herein for illustrative purposes, it should be appreciated that the invention is not limited thereto. Moreover, other types of fluid delivery apparatus may be substituted therefor, such as side sprayers used with kitchen faucets.

Still referring to FIG. 1, a user interface 14 is coupled to the fluid delivery apparatus 12. Fluid delivery apparatus 12 is operably coupled to a fluid control device, illustratively electrically actuated fluid control valves 18 and 20. More particularly, valves 18 and 20 may comprise conventional motor or solenoid driven valves. In the illustrative embodiment, hot water valve 18 is fluidly coupled to a hot water supply 19, while the cold water valve 20 is fluidly coupled to a cold water supply 21. Valves 18 and 20 are in electrical communication with a controller 22. Moreover, controller 22 is configured to transmit signals through communication lines 24 and 26 in order to adjust valves 18 and 20, respectively. In turn, the flow rate and temperature of fluid supplied to an output line 28, and hence fluid delivery apparatus 12, is controlled. Additional details of interaction between an illustrative controller and valves are provided in U.S. patent application Ser. No. 11/109,281, filed Apr. 19, 2005, entitled “ELECTRONIC PROPORTIONING VALVE,” which is expressly incorporated by reference herein.

First and second knobs or handles 30 and 32 are illustratively coupled to controller 22 through communication lines 31 and 33, respectively, for controlling operation of valves 18 and 20. More particularly, rotary position sensors or encoders (not shown) may be operably coupled to handles 30 and 32 for generating signals for transmission through communication lines 31 and 33. Additional details of illustrative handles 30 and 32 are provided in U.S. patent application Ser. No. 11/558,188, filed Nov. 9, 2006, entitled “DUAL FUNCTION HANDLES FOR A FAUCET ASSEMBLY,” which is expressly incorporated by reference herein. An optional electronic user interface, such as keypad 34, may also be in communication with controller 22.

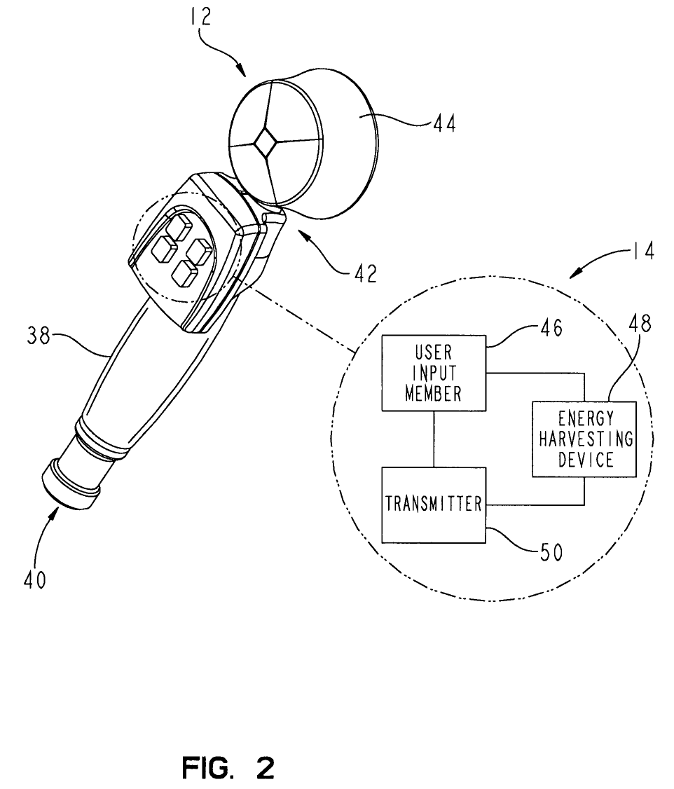

Referring to FIG. 2, fluid delivery apparatus 12 is shown as including a housing 38 configured to be held by a user and including a fluid inlet 40 and a fluid outlet 42. A conventional sprayhead 44 is illustratively coupled to the fluid outlet 42. As is known in the art, the sprayhead 44 may provide a variety of flow patterns, such as stream and spray, to the user. User interface 14 illustratively includes a user input member 46, an energy harvesting device 48 and a transmitter 50. User input member 46 is operably coupled to energy harvesting device 48, as well as transmitter 50. Energy harvesting device 48 is electrically coupled to transmitter 50.

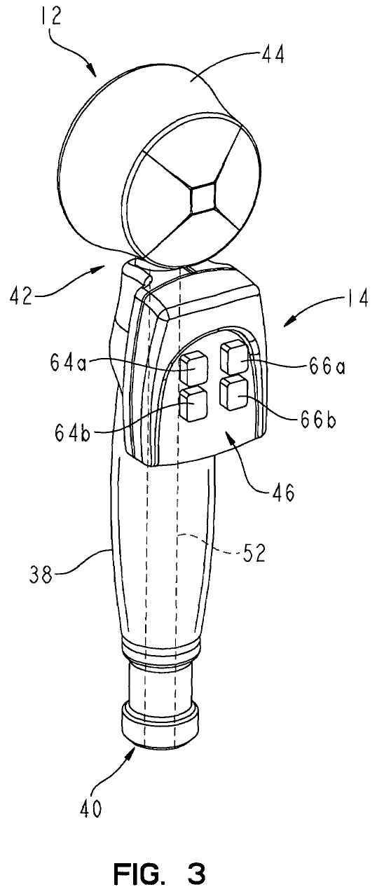

Further details of an illustrative embodiment fluid delivery apparatus 12 are shown in FIG. 3. Fluid delivery apparatus 12 includes a sprayhead 44 coupled to housing 38. A fluid passageway 52 illustratively extends between inlet 40 and outlet 42, and is fluidly coupled to sprayhead 44. In one illustrative embodiment, user interface 14 may be retrofited to an existing housing 38.

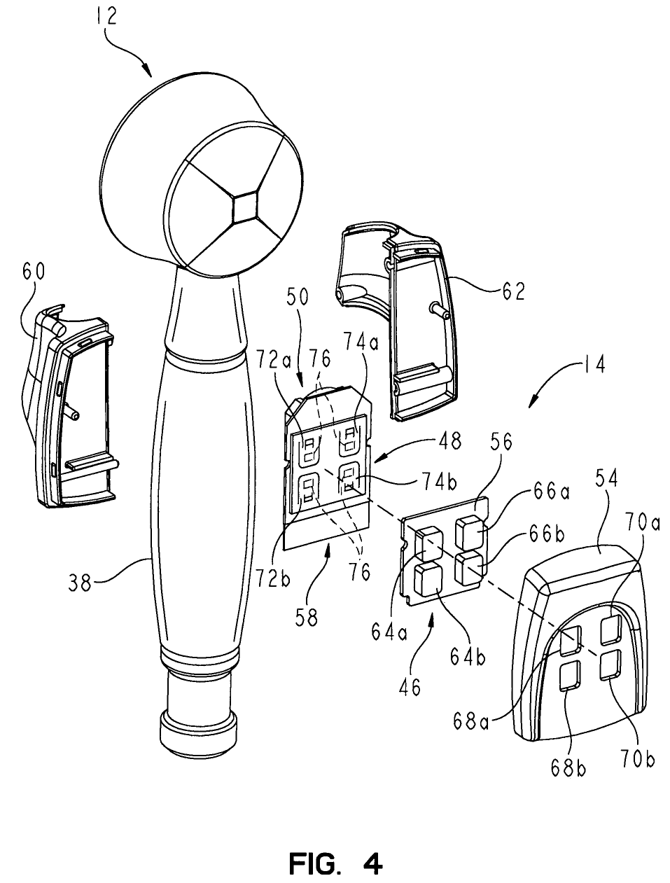

As illustrated in FIG. 4, fluid delivery apparatus 12 including user interface 14 is shown in even greater detail. User interface 14 includes face plate 54, control pad 56, interface device 58 and couplers 60 and 62. Housing 38 supports couplers 60 and 62. Couplers 60 and 62 may be secured together or clamped in a conventional manner at housing 38. Couplers 60 and 62 support interface device 58. Interface device 58, in turn, supports and is generally coplanar with pad 56. Pad 56 includes a plurality of buttons 64 and 66 defining user input member 46. Couplers 60 and 62 also supports face plate 54. Face plate 54 defines a cavity (not shown) and apertures 68 and 70 through which buttons 64 and 66 extend. Pad 56 and interface device 58 are at least partially disposed within the cavity of face plate 54.

Interface device 58 illustratively includes a plurality of energy harvesting devices 48 in the form of energy autonomous switches 72 and 74, each including an associated electro-dynamic energy transducer 76. Interface device 58 further illustratively includes transmitter 50 associated with switches 72 and 74. Switches 72a, 72b are associated with buttons 64a, 64b, while switches 74a, 74b are associated with buttons 66a, 66b, respectively. More particularly, depressing button 64a, 64b, 66a, 66b activates the transducer 76 associated with switch 72a, 72b, 74a, 74b, respectively, thereby causing transmitter 50 to transmit a radio frequency (RF) signal 78 to an RF receiver (not shown) of controller 22. The transmitter 50 emitting RF signal 78 is powered by transducer 76 when button 64a, 64b, 66a, 66b is depressed. More particularly, transducer 76 converts the mechanical energy of depressing button 64a, 64b, 66a, 66b to electrical energy powering transmitter 50.

Interface device 58, including energy harvesting devices 48 and transmitter 50, may illustratively comprise pushbutton transmitter Module PTM 200, available from EnOcean GmbH of Oberhaching, Germany. Additional details of an illustrative energy harvesting device 48 are provided in U.S. Pat. No. 7,019,241, which is expressly incorporated by reference herein.

During operation of the illustrated fluid delivery system 10, interface device 58 does not require a battery or external power source. Interface device 58 controls water flow and temperature through operation of valves 18 and 20 by controller 22.

In the illustrative embodiment, buttons 64a and 64b are depressed to transmit RF signals 78 to controller 22 for operating valves 18 and 20 to increase and decrease flow rate, respectively. Similarly, buttons 66a and 66b are illustratively depressed to transmit RF signals 78 to controller 22 for operating valves 18 and 20 to increase and decrease fluid temperature, respectively. As detailed above, the power source for interface device 58 is the mechanical act of depressing buttons 64 and 66. Therefore, fluid delivery system 10 does not require a battery or an external power source. Fluid delivery system 10 further eliminates maintenance required to service batteries and problems associated with sealing a battery from moisture. In fact, since no batteries are required within fluid delivery apparatus 12, the entire assembly (including face plate 54 and couplers 60 and 62) could be factory sealed in a conventional manner, for example through glue, solvent bonding, or sonic welding. Such sealing reduces or eliminates the possibility of moisture entering the assembly and adversely affecting the electronics secured therein.

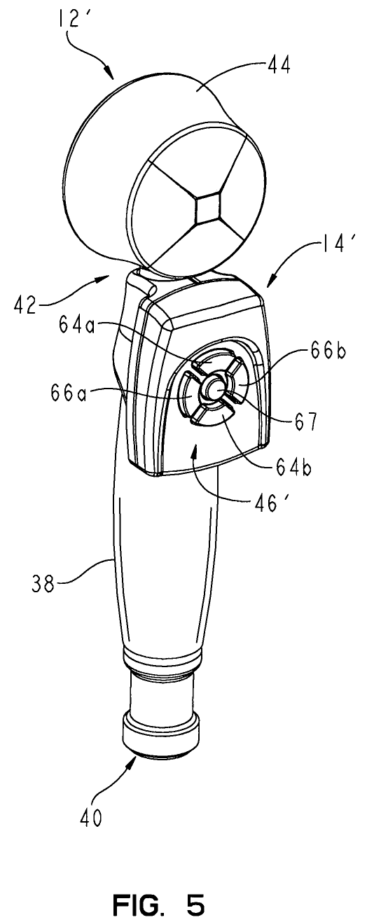

With reference now to FIG. 5, a further illustrative embodiment fluid delivery apparatus 12′ is shown as including a housing 38 and sprayhead 44 similar to that illustrated above in connection with fluid delivery apparatus 12 of FIGS. 2-4. Apparatus 12′ includes an alternative embodiment user interface 14′ including user input member 46′ having a plurality of buttons 64 and 66 arranged in an annular pattern around a center button 67. As noted above, the buttons 64a and 64b are configured to control flow rate, while buttons 66a and 66b are configured to control temperature. Button 67 may be provided to activate and/or deactivate the fluid delivery system 10. The buttons 64, 66 and 67 may all cooperate with energy harvesting device 48 in the form of an interface device (not shown) similar to interface device 58 as described above.

Although the invention has been described in detail with reference to certain preferred embodiments, variations and modifications exist within the spirit and scope of the invention as described and defined in the following claims.

1. A hand-held fluid delivery apparatus comprising:
a housing;
a sprayhead coupled to the housing; and
an energy harvesting device supported by the housing.

2. The hand-held fluid delivery apparatus of claim 1, further comprising a user interface including the energy harvesting device.

3. The hand-held fluid delivery apparatus of claim 2, wherein the user interface communicates with a fluid control device.

4. The hand-held fluid delivery apparatus of claim 3, wherein the fluid control device comprises an electrically actuated valve configured to control the flow of fluid to the sprayhead.

5. The hand-held fluid delivery apparatus of claim 3, wherein the user interface includes a transmitter configured to transmit a wireless signal to the fluid control device.

6. The hand-held fluid delivery apparatus of claim 5, wherein the transmitter is configured to transmit a radio frequency signal.

7. The hand-held fluid delivery apparatus of claim 1, further comprising:
a user interface including a transmitter, a user input member operably coupled to the transmitter, and the energy harvesting device; and
wherein the energy harvesting device includes a transducer configured to convert mechanical energy supplied to the user input member to electrical energy supplied to the transmitter.

8. A hand-held fluid delivery apparatus comprising:
a housing including a fluid inlet and a fluid outlet;
a user interface coupled to the housing, the user interface including a user input member, an energy harvesting device operably coupled to the user input member, and a transmitter electrically coupled to the energy harvesting device; and
wherein the energy harvesting device is configured to convert mechanical energy from the user input member to electrical energy supplied to the transmitter.

9. The hand-held fluid delivery apparatus of claim 8, wherein the transmitter communicates with a fluid control device.

10. The hand-held fluid delivery apparatus of claim 9, wherein the fluid control device comprises an electrically actuated valve configured to control the flow of fluid to the outlet of the housing.

11. The hand-held fluid delivery apparatus of claim 9 wherein the user interface includes a transmitter configured to transmit a wireless signal to the fluid control device.

12. The hand-held fluid delivery apparatus of claim 9, further comprising a controller in communication with the fluid control device.

13. The hand-held fluid delivery apparatus of claim 10, wherein the controller responds to wireless signals received from the transmitter of the user interface.

14. The hand-held fluid delivery apparatus of claim 10, wherein the user input member includes a water flow control input member in communication with the transmitter for controlling the valve to adjust the flow rate of fluid supplied to the outlet of the housing, and a temperature control input member in communication with the transmitter for controlling the valve to adjust the temperature of fluid supplied to the outlet of the housing.

15. A fluid delivery system comprising:
a fluid control device;
a user interface including an energy autonomous switch, and a transmitter electrically coupled to the energy autonomous switch and configured to emit a signal to the fluid control device; and
wherein the energy autonomous switch is configured to convert mechanical energy to electrical energy supplied to the transmitter.

16. The fluid delivery system of claim 15, wherein the transmitter is configured to transmit a wireless signal to the fluid control device.

17. The fluid delivery system of claim 15, wherein the fluid control device comprises an electrically actuated valve configured to control the flow of fluid in response to operation of the user interface.

18. The fluid delivery system of claim 17, further comprising a hand-held housing including a fluid outlet and a fluid inlet, the user interface supported by the housing, and the fluid control device configured to control the flow of fluid through the fluid outlet in response to the signal emitted by the transmitter.

19. The fluid delivery system of claim 18, further comprising a controller in communication with the valve.

20. The fluid delivery system of claim 19, wherein the user input member includes a water flow control input member in communication with the transmitter for controlling the valve to adjust the flow rate of fluid supplied to the outlet of the housing, and a temperature control input member in communication with the transmitter for controlling the valve to adjust the temperature of fluid supplied to the outlet of the housing.
